(19) United States
(12) Patent Application Publication
(10) Pub. No.: US 2025/0183938 A1
(43) Pub. Date: Jun. 5, 2025

(54) TECHNIQUES FOR PASSIVE INTERMODULATION AVOIDANCE

(71) Applicant: Telefonaktiebolaget LM Ericsson (publ), Stockholm (SE)

(72) Inventors: Martin ALLANDER, Stockholm (SE); Mark WYVILLE, Ottawa (CA); Torbjörn WIGREN, Uppsala (SE)

(21) Appl. No.: 18/842,254

(22) PCT Filed: Mar. 7, 2022
(86) PCT No.: PCT/SE2022/050216

§ 371 Date: Aug. 28, 2024

(51) Int. Cl. H04B 1/525; H04B 15/02; H04W 72/1273; H04W 72/54

(52) U.S. Cl. CPC H04B 1/525; H04B 15/02; H04W 72/1273; H04W 72/54

(57) ABSTRACT

Mechanisms for PIM avoidance. A method is performed by a controller. The method includes performing, for a set of downlink PIM avoidance actions, uplink probing of a radio channel over which uplink PIM is received. The uplink probing for each downlink PIM avoidance action in the set of downlink PIM avoidance actions comprises obtaining, in a probing instant, a measured improvement of the uplink PIM when having applied the downlink PIM avoidance action. The method includes selecting one of the downlink PIM avoidance actions based on the measured improvement for each of the downlink PIM avoidance actions as obtained during the uplink probing. The method includes applying the selected downlink PIM avoidance action to downlink transmission resources transmitted in a data transmission instant following the probing instant.

### TECHNICAL FIELD

Embodiments presented herein relate to a method, a controller, a computer program, and a computer program product for passive intermodulation (PIM) avoidance.

### BACKGROUND

In general terms, PIM is caused by passive objects, such as filters, duplexers, connectors, antennas and so forth, exhibiting nonlinear behavior in the vicinity of radio signals. PIM can cause an interference signal to be generated that can couple into a receiver and degrade the receiver's sensitivity.

Depending on the location of the component that generates the PIM, the PIM is categorized as either internal or external. For example, PIM generated by the filters of the transmission (TX) radio chains in the antenna system at the cell site, loose cable connections, dirty connectors, poor performance duplexers, and aged antennas, is called internal PIM whereas PIM generated by a metal fence on the roof top of a building, a metal roof, or even a drainpipe, in vicinity of the cell site is called external PIM. External PIM thus refers to the case where the PIM occurs after the signals have left the transmitter antenna with the resultant intermodulation reflecting back into the receiver. PIM might cause the transmission power of the cell site to be backed off in order to avoid PIM to affect the receiver (RX) radio chains in the antenna system of the cell site, thus compromising the network performance. For example, a 1-dB drop in uplink sensitivity caused by PIM might reduce coverage by as much as 11% in a macro network. Further, PIM is a super-linear effect, meaning that the PIM power can increase as a power of the downlink transmit power. For example, for third-order PIM every decibel (dB) of transmit power increase could result in 3 dB of PIM power increase in the uplink.

To explain how PIM is generated at a high level, consider FIG. 1. FIG. 1 at (a) illustrates a communications network 100 where embodiments presented herein can be applied. The communications network 100 comprises an access network node 110, such as a radio access network node, radio base station, base transceiver station, node B (NB), evolved node B (eNB), gNB, access point, integrated access and access node, etc. configured to provide network access to user equipment 120a, 120b in carriers 120a, 120b. A PIM source 130 is located in the vicinity of the antenna system of an access network node 110. FIG. 1 at (b) shows a representation of the power spectral density (PSD) as a function of frequency. In the example of FIG. 1, downlink transmission in two frequency bands with carrier frequencies f₁ and f₂ mix nonlinearly in the PIM source 130. This results in new interference signals with a variety of center frequencies. Only one of these signals is shown in the power spectral density, centered at the frequency f_{PIM}=2f₁−f₂. In this case, it is for illustrative purposes assumed that the linear combination 2f₁−f₂ happens to be located within the uplink band of the access network node 110, manifesting itself as additional uplink interference. The uplink radio channel for the access network node 110 is marked at reference numeral 140, and the uplink frequency band for the access network node 110 is marked at reference numeral 150. The interference typically has a wider bandwidth than the downlink signals that caused this uplink PIM. This wider bandwidth is an effect of the nonlinear mixing.

Three techniques to mitigate the impact of PIM, namely uplink PIM cancellation, downlink PIM avoidance by beamformed transmission, and general power reducing PIM avoidance, will be briefly summarized next.

PIM cancellation algorithms are designed to estimate parts of the complete PIM channel from downlink transmission to uplink reception. Given the estimated signal, a predicted signal can be computed and subtracted from the received signal. In case the predicted signal is an accurate model of the received uplink PIM, a substantial reduction in the uplink PIM can be obtained. One common drawback of all PIM cancellation algorithms is the computational complexity. This computational complexity is much higher than that of conventional channel estimation since non-linear basis functions must be created. PIM cancellation also requires measurement of both downlink transmission and uplink PIM.

PIM avoidance by beamformed transmission aims at avoiding beams of an advanced antenna system used for transmission to be pointed in the direction of the PIM source. This might require estimation of the location of the PIM source, which might not be known in advance. Therefore, techniques have been proposed to estimate a subspace of the beam space generated by the antenna array system where the PIM source is located. Generation of beams in this subspace is then avoided for downlink transmissions. This technique is only applicable for advanced antenna systems, and thus for (radio) access network nodes equipped with large antenna arrays. Further, this technique limits the number of possible directions in which beams can be used for downlink transmission.

PIM avoidance in general is applicable to any type of access network node. Once the frequency bands in which downlink transmissions are used that causes the uplink PIM are identified, the uplink PIM can be reduced by at least periodically avoiding transmission in these identified frequency bands. PIM avoidance can thereby reduce the uplink PIM depending on how much of the frequency bands can be muted. For network deployments a set of restrictions is defined on how much muting in downlink transmissions is allowed, as an upper limit on how much downlink throughput and capacity can be sacrificed. The implication is that the muting might be implemented sporadically and non-continuously, essentially adding more variations to the uplink signal to interference and noise ratio (SINR). Variations in the SINR must be considered carefully when used in uplink link adaptation, since the uplink PIM is mixed with the interference from other user equipment.

Hence, there is still a need for improved PIM mitigation techniques.

### SUMMARY

An object of embodiments herein is to provide techniques for efficient PIM avoidance that does not suffer from the issues noted above, or where the above noted issues at least have been mitigated or reduced.

According to a first aspect there is presented a method for PIM avoidance. The method is performed by a controller. The method comprises performing, for a set of downlink PIM avoidance actions, uplink probing of a radio channel over which uplink PIM is received. The uplink probing for each downlink PIM avoidance action in the set of downlink PIM avoidance actions comprises obtaining, in a probing instant, a measured improvement of the uplink PIM when having applied the downlink PIM avoidance action. The method comprises selecting one of the downlink PIM avoidance actions based on the measured improvement for each of the downlink PIM avoidance actions as obtained during the uplink probing. The method comprises applying the selected downlink PIM avoidance action to downlink transmission resources transmitted in a data transmission instant following the probing instant.

According to a second aspect there is presented a controller for PIM avoidance. The controller comprises processing circuitry. The processing circuitry is configured to cause the controller to perform, for a set of downlink PIM avoidance actions, uplink probing of a radio channel over which uplink PIM is received. The uplink probing for each downlink PIM avoidance action in the set of downlink PIM avoidance actions comprises obtaining, in a probing instant, a measured improvement of the uplink PIM when having applied the downlink PIM avoidance action. The processing circuitry is configured to cause the controller to select one of the downlink PIM avoidance actions based on the measured improvement for each of the downlink PIM avoidance actions as obtained during the uplink probing. The processing circuitry is configured to cause the controller to apply the selected downlink PIM avoidance action to downlink transmission resources transmitted in a data transmission instant following the probing instant.

According to a third aspect there is presented a controller for PIM avoidance. The controller comprises a probe module configured to perform, for a set of downlink PIM avoidance actions, uplink probing of a radio channel over which uplink PIM is received. The uplink probing for each downlink PIM avoidance action in the set of downlink PIM avoidance actions comprises obtaining, in a probing instant, a measured improvement of the uplink PIM when having applied the downlink PIM avoidance action. The controller comprises a select module configured to select one of the downlink PIM avoidance actions based on the measured improvement for each of the downlink PIM avoidance actions as obtained during the uplink probing. The controller comprises an apply module configured to apply the selected downlink PIM avoidance action to downlink transmission resources transmitted in a data transmission instant following the probing instant.

According to a fourth aspect there is presented a computer program for PIM avoidance, the computer program comprising computer program code which, when run on a controller, causes the controller to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide efficient PIM avoidance that does not suffer from the issues noted above.

Advantageously, these aspects enable the PIM avoidance to be intelligently operated.

Advantageously, these aspects enable the reduction in uplink interference for a specific downlink PIM avoidance action to be predicted.

Advantageously, these aspects enable reliable uplink signal to interference plus noise ratio prediction for uplink link adaptation.

Advantageously, these aspects enable quantification of which downlink PIM avoidance action to be applied for each data transmission instant.

Advantageously, these aspects enable determination whether any downlink PIM avoidance action should be applied or not. For example, if the estimated uplink improvements are non-significant, then it can be determined that no downlink PIM avoidance action is to be applied.

Advantageously, these aspects enable observability of the downlink PIM avoidance actions.

Advantageously, these aspects can be used to provide resource prioritization in multi-victim scenarios.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communications network according to embodiments;

FIG. 2 is a flowchart of methods according to embodiments;

FIGS. 3, 4, 5, 6, and 7 are block diagrams of controllers according to embodiments;

FIG. 8 schematically illustrates an examples of measured improvement for a downlink PIM avoidance action as a function of frequency.

FIG. 9 is a schematic diagram showing functional units of a controller according to an embodiment;

FIG. 10 is a schematic diagram showing functional modules of a controller according to an embodiment; and

FIG. 11 shows one example of a computer program product comprising computer readable storage medium according to an embodiment.

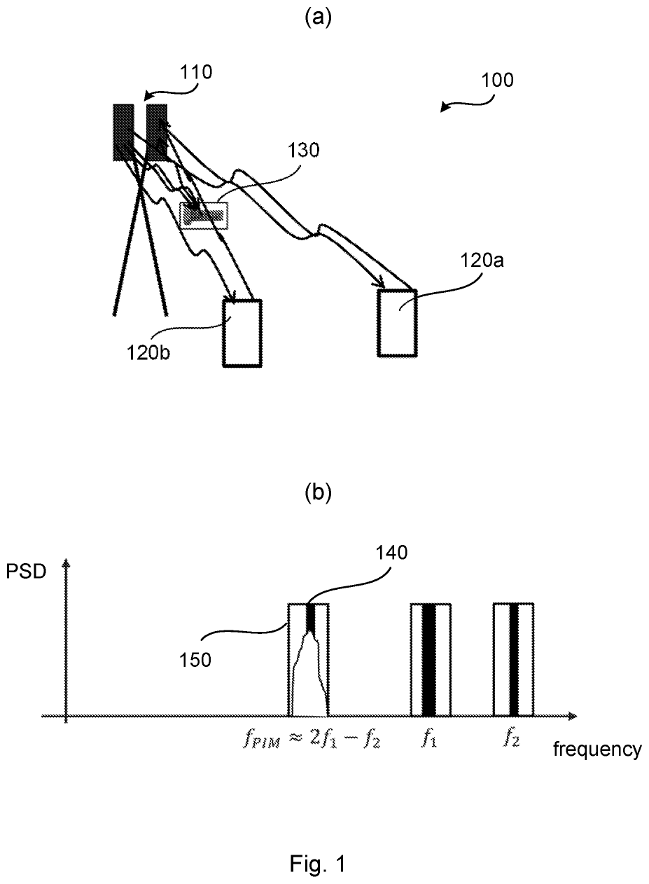

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As noted above there is still a need for improved PIM mitigation techniques

The embodiments disclosed herein therefore relate to mechanisms for PIM avoidance. In order to obtain such mechanisms there is provided a controller, a method performed by the controller, a computer program product comprising code, for example in the form of a computer program, that when run on a controller, causes the controller to perform the method.

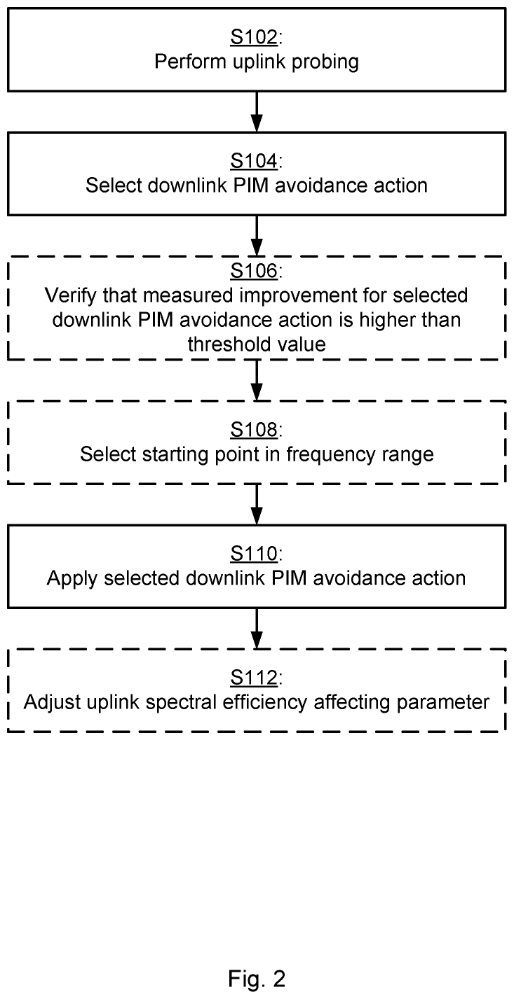

FIG. 2 is a flowchart illustrating embodiments of methods for PIM avoidance. The methods are performed by the controller. The methods are advantageously provided as computer programs 1120.
S102: The controller performs, for a set of downlink PIM avoidance actions, uplink probing of a radio channel over which uplink PIM is received. The uplink probing for each downlink PIM avoidance action in the set of downlink PIM avoidance actions comprises obtaining, in a probing instant, a measured improvement of the uplink PIM when having applied the downlink PIM avoidance action. In some of the figures, this measured improvement is denoted ΔIpN.
S104: The controller selects one of the downlink PIM avoidance actions based on the measured improvement for each of the downlink PIM avoidance actions as obtained during the uplink probing; and
S110: The controller applies the selected downlink PIM avoidance action to downlink transmission resources transmitted in a data transmission instant following the probing instant.

This method represents a way to measure the expected improvement of the uplink PIM as achieved for a given downlink PIM avoidance action. The measurement is defined by the PIM impacted uplink metric. By selectively probing the radio channel in the uplink, a sequence of measurements can be obtained for each downlink PIM avoidance action. This enables the most suitable downlink PIM avoidance action to be selected and applied, for the given uplink PIM and radio channel conditions. This also improves the effectiveness of traditional PIM avoidance techniques.

Embodiments relating to further details of PIM avoidance as performed by the controller will now be disclosed.

It is appreciated that there could be different types of downlink PIM avoidance actions. In some non-limiting examples, the downlink PIM avoidance actions pertain to any, or any combination, of: limiting downlink load in at least one carrier to a fixed limit, minimizing downlink load in at least one carrier to a fixed limit, limiting the downlink load from a certain side along the frequency axis of downlink carriers when considered in the frequency domain, a sequence or repetition pattern according to which the selected downlink PIM avoidance action is to be performed.

It is appreciated that there could be different types of PIM impacted uplink metrics that can be measured with and without the downlink PIM avoidance actions applied to measure the impact of the downlink PIM avoidance action. In some non-limiting examples, the PIM impacted uplink metric is any of: uplink SINR, uplink interference plus noise, uplink throughput, block error rate (BLER), uplink spectral efficiency. In some of the figures, this PIM impacted uplink metric is denoted IpN.

By performing selective filtering, with one filter for the overall interference level when no downlink PIM avoidance action is performed, and with additional filters for each downlink PIM avoidance action taken, a measurement can be formed. In some aspects, the measured improvement pertains to a difference between the average PIM impacted uplink metric level (such as average interference plus noise level or the like) for when no downlink PIM avoidance action is applied and the PIM impacted uplink metric level connected to the performed downlink PIM avoidance action. Particularly, in some embodiments, the measured improvement for each respective downlink PIM avoidance action is obtained as a difference between an average PIM impacted uplink metric level for when no downlink PIM avoidance action is applied and a PIM impacted uplink metric level for when a respective downlink PIM avoidance action is applied in the probing instant.

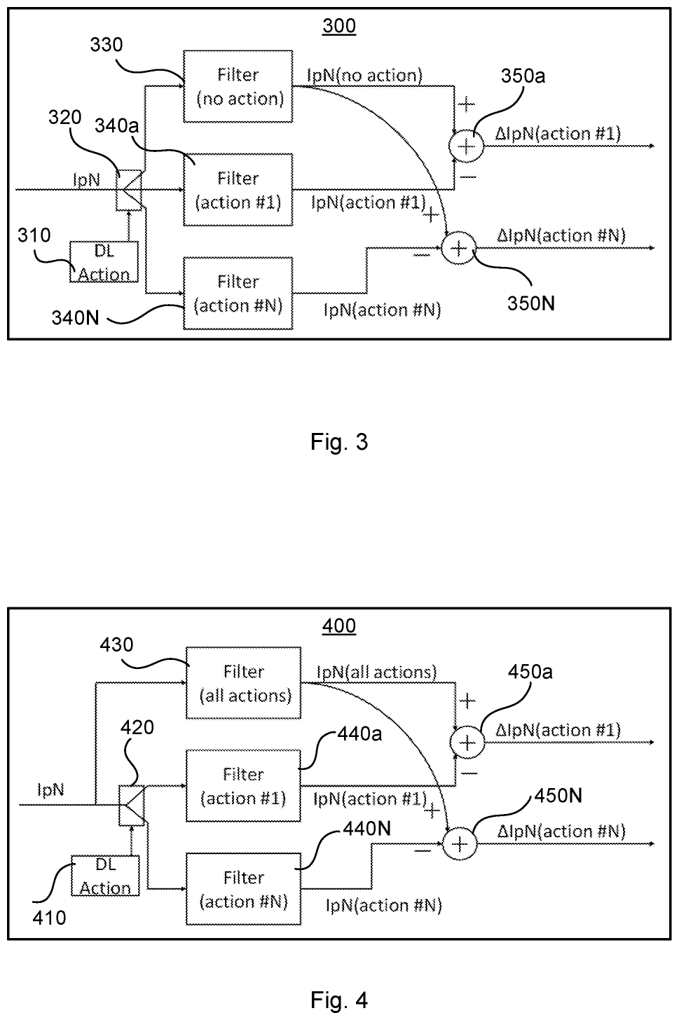

Intermediate reference is here made to the block diagram of the controller 300 illustrated in FIG. 3. The controller 300 comprises a bank 310 of available downlink PIM avoidance actions. Application of the downlink PIM avoidance actions is represented by filters 340a, 340N, one for each downlink PIM avoidance action. A separate filter 330 represents a reference case where none of the downlink PIM avoidance actions are applied and thus corresponds to the average PIM impacted uplink metric level (such as average interference plus noise level or the like) for when no downlink PIM avoidance action is applied. For which of the downlink PIM avoidance actions the uplink probing for the current probing instant is to be performed is determined by setting of a switch 320. This also activates the filter 340a, 340N corresponding to the downlink PIM avoidance action. The measured improvements of the uplink PIM when having applied each of the available downlink PIM avoidance actions are found, in adders 350a, 350N, as a difference between an average PIM impacted uplink metric level for when no downlink PIM avoidance action is applied and a PIM impacted uplink metric level for when a respective downlink PIM avoidance action is applied in the probing instant. It is appreciated that although FIG. 3 only illustrates two available downlink PIM avoidance actions, the herein disclosed embodiments are applicable to any number N of available downlink PIM avoidance actions.

Intermediate reference is next made to the block diagram of the controller 400 illustrated in FIG. 4. The controller 400 comprises a bank 410 of available downlink PIM avoidance actions. Application of the downlink PIM avoidance actions is represented by filters 440a, 440N, one for each downlink PIM avoidance action. A separate filter 430 represents a reference that processes data for the case of all of the downlink PIM avoidance actions, as well as for none of the downlink PIM avoidance actions. One benefit of the reference filter in 430 is that if PIM avoidance is turned-off (for example when the measurements show that performing any of the available downlink PIM avoidance actions it is not helping) then the filter in 430 can continue being used without disruption (i.e., the data inside the filter 430 does not need to be purged before considering the output values to be valid). This is not the case for the filter 330. For which of the downlink PIM avoidance actions the uplink probing for the current probing instant is to be performed is determined by setting of a switch 420. This also activates the filter 440a, 440N corresponding to the downlink PIM avoidance action. The measured improvements of the uplink PIM when having applied each of the available downlink PIM avoidance actions are found in adders 450a, 450N, as a difference between an average PIM impacted uplink metric level for when no downlink PIM avoidance action is applied and a PIM impacted uplink metric level for when a respective downlink PIM avoidance action is applied in the probing instant. It is appreciated that although FIG. 4 only illustrates two available downlink PIM avoidance actions, the herein disclosed embodiments are applicable to any number N of available downlink PIM avoidance actions.

By connecting a downlink PIM avoidance action to the measured improvement of the uplink PIM, it is possible to identify how much a downlink PIM avoidance action will help the uplink performance. A high measured improvement implies that certain downlink PIM avoidance action is more valuable compared to another certain downlink PIM avoidance action with a low measured improvement. Therefore, in some embodiments, the downlink PIM avoidance action yielding highest measured improvement of the uplink PIM is selected. This enables the optimal downlink PIM avoidance action out of all available downlink PIM avoidance actions to be selected and applied, for the given uplink PIM and radio channel conditions.

However, it could be that some, or even all of the available downlink PIM avoidance actions only yield some limited measured improvement of the uplink PIM. This could indicate that it would not be beneficial to apply any of the available downlink PIM avoidance actions. Hence, a check can be made if the measured improvement of the uplink PIM for a given downlink PIM avoidance action is above some threshold value before this given downlink PIM avoidance action is considered for application. In particular, in some embodiments the controller is configured to perform (optional) step S106 before step S110:
S106: The controller verifies that the measured improvement of the uplink PIM of the selected downlink PIM avoidance action is higher than a threshold value before applying the selected downlink PIM avoidance action.

This can avoid unnecessary application of any downlink PIM avoidance action if the resulting improvement of the uplink PIM is not significant enough.

In general terms, the downlink traffic load as well as the conditions of the radio channel, external interference, etc. are susceptible to change over time. By regularly probing the radio channel in the uplink, and thus continually monitor the measured improvement of the uplink PIM for each downlink PIM avoidance action, these changes over time can be captured. This enables changes in the measured improvement of the uplink PIM to be captured over time. It is appreciated that there could be different intervals at which the probing of the radio channel in the uplink is performed. In some non-limiting examples, the data transmission instant is part of a transmission slot, where one instant of the probing instant occurs every 10th to once every 1000th transmission slot, preferably between once every 25th to every 500th transmission slot, more preferably between once every 50th to once every 150th transmission slot, even more preferably between once every 75th to once every 125th transmission slot.

By testing a given downlink PIM avoidance action in its probing instant at such regular intervals, the measured improvement of the uplink PIM for this given downlink PIM avoidance action can be quantified. This gives an understanding of the PIM contribution to the overall uplink performance. Depending on the measured improvement of the uplink PIM for the given downlink PIM avoidance action the controller can decide if this downlink PIM avoidance action is a candidate to be selected or not.

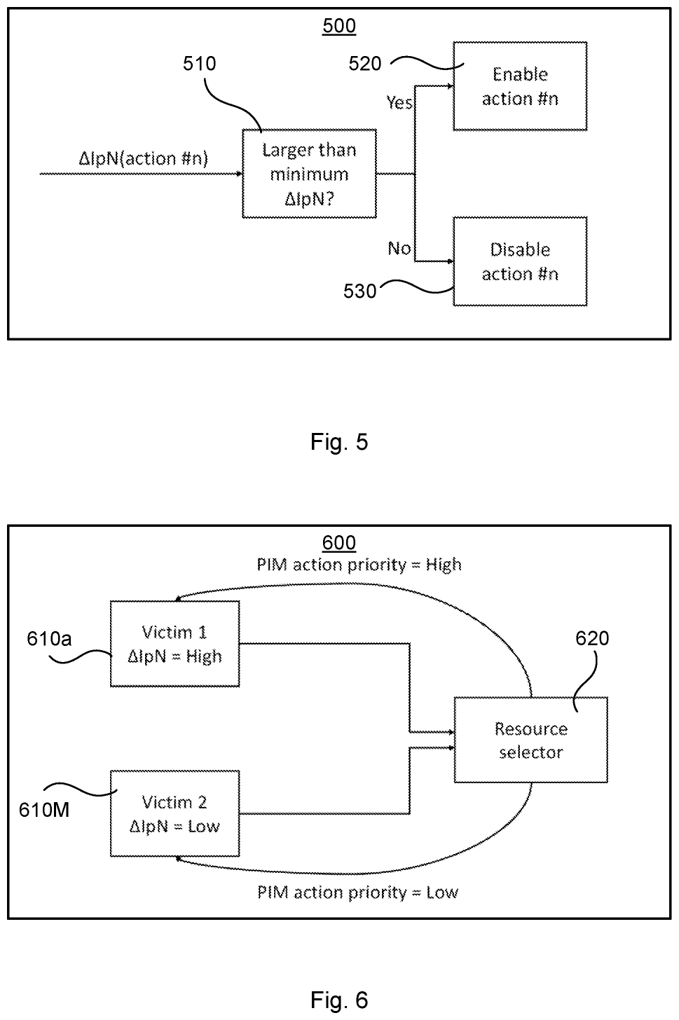

Intermediate reference is here made to the block diagram of the controller 500 illustrated in FIG. 5. The controller 500 comprises a comparison block 510 in which the measured improvement of the uplink PIM for a given downlink PIM avoidance action (represented by downlink PIM avoidance action number n out of N available downlink PIM avoidance actions) is compared to a threshold value. If the measured improvement is higher than the threshold value, then the given downlink PIM avoidance action is selectable to be applied and is entered in bank 520. Otherwise, the given downlink PIM avoidance action is not selectable to be applied and is entered in bank 530.

It is foreseen that there might be more than one, or even multiple entities, component, or devices suffering from the uplink PIM. Such entities, component, and devices are hereinafter referred to as PIM victims. In some non-limiting examples, the PIM victims are different uplink carriers. These different uplink carriers might be received on the same or different antenna panel within the same access network node, might be received on different access network nodes, might be received using the same or different radio access technologies (RATs). In such cases where two or more PIM victims share a PIM source, both PIM victims might be considered viable for PIM avoidance operations. A downlink PIM avoidance action can then be shared between the PIM victims as a function of the measured improvement of the uplink PIM for each given downlink PIM avoidance actions for each PIM victim. In particular, in some embodiments, uplink PIM is affecting at least two PIM victims, and the uplink probing for each downlink PIM avoidance action is performed for each of the at least two PIM victims. The selected downlink PIM avoidance action is shared between downlink transmission resources associated with the at least two PIM victims according to the measured improvements of the uplink PIM resulting from the uplink probing for each of the at least two PIM victims. In this way, the downlink PIM avoidance action for a PIM victim for which the measured improvement of the uplink PIM is high is applied to more downlink transmission resources than for a PIM victim for which the measured improvement of the uplink PIM is low.

Intermediate reference is here made to the block diagram of the controller 600 illustrated in FIG. 6. The controller 600 comprises banks 610a, 610M for holding the measured improvement of the uplink PIM for each PIM victim (denoted “Victim 1” and “Victim 2”). The controller 600 further comprises a selector 620 for sharing the selected downlink PIM avoidance action between downlink transmission resources associated with the PIM victims according to the measured improvement of the uplink PIM for each PIM victim as stored in the banks 610a, 610M. As illustrated in the figure, a higher measured improvement of the uplink PIM yields a higher priority when the selected downlink PIM avoidance action is shared between downlink transmission resources associated with the PIM victims.

With the measured improvement of the uplink PIM, the uplink performance improvement, for example uplink SINR, resulting from an upcoming downlink PIM avoidance action can be anticipated. This enables the setting of uplink spectral efficiency affecting parameters, or link adaptation parameters, such as modulation and coding scheme (MCS), transport block (TB) size, etc. to be set more carefully. Hence, in some embodiments the controller is configured to perform (optional) step S112:
S112: The controller adjusts, as a function of the measured improvement of the uplink PIM for the selected downlink PIM avoidance action, an uplink spectral efficiency affecting parameter.

This can increase the uplink spectral efficiency.

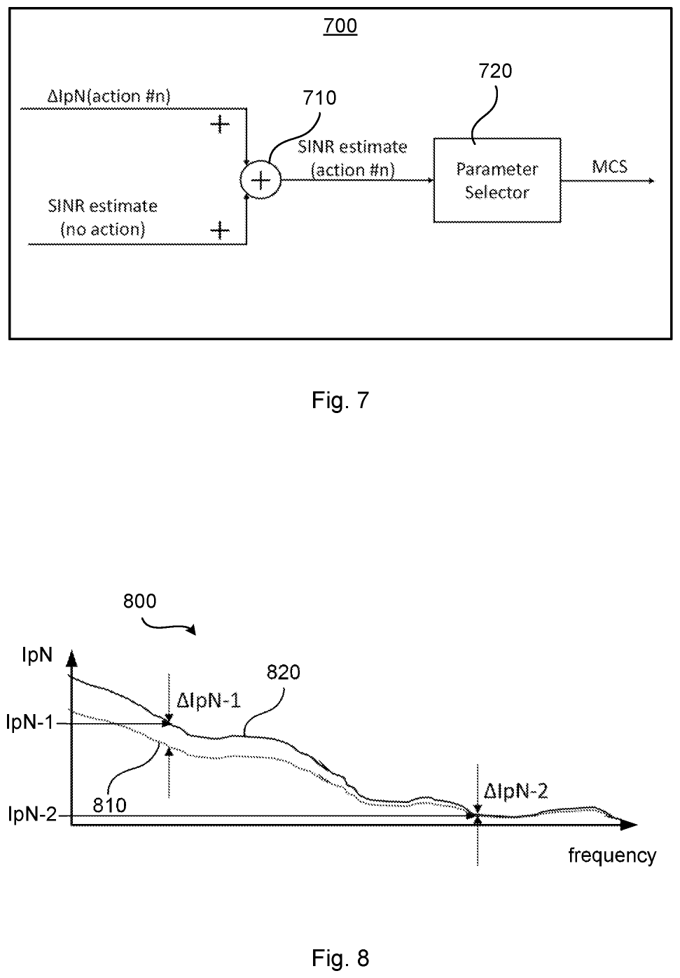

Intermediate reference is here made to the block diagram of the controller 500 illustrated in FIG. 7. The controller 700 comprises an adder 710 for estimating the uplink SINR from the measured improvement of the uplink PIM for the selected downlink PIM avoidance action (represented by downlink PIM avoidance action number n out of N available downlink PIM avoidance actions) and an estimate of the uplink SINR in case no downlink PIM avoidance action is applied. The output from the adder 710 is thus the estimated uplink SINR. The controller 700 further comprises a selector 720 for selecting the uplink spectral efficiency affecting parameter, such as MCS, TB size, etc. as a function of the estimated uplink SINR.

In some aspects, in case the the measured improvement of the uplink PIM for the selected downlink PIM avoidance action has a trend that indicates that the PIM is either more significant on the lower-end or the upper-end of the available uplink spectrum, the starting point at which carriers for on which uplink transmission resources are to be transmitted in the data transmission instant can be selected to the side (i.e., either the lower-end or the upper-end) that has the lowest measured improvement of the uplink PIM. This increases the uplink user throughput when the uplink PIM is the dominant interference source. In this respect, the uplink PIM might, alternatively, be strongest in the middle of the available uplink spectrum, and the placement of the carriers can be selected accordingly. Particularly, in some embodiments the controller is configured to perform (optional) step S108:
S108: The controller selects, as a function of the measured improvement of the uplink PIM for the selected downlink PIM avoidance action, a starting point in a frequency range for carriers on which uplink transmission resources are to be transmitted in the data transmission instant.

Intermediate reference is here made to FIG. 8 which at 800 illustrates an example of uplink interference plus noise with and without a downlink PIM avoidance action being applied. The uplink interference plus noise resulting from the downlink PIM avoidance action being applied is shown at 810 whereas the uplink interference plus noise resulting from the downlink PIM avoidance action not being applied is shown at 820. The measured improvement (denoted ΔIpN-1 and ΔIpN-2, respectively) is taken at two places along the frequency axis. The measured uplink interference plus noise (denoted IpN-1 and IpN-2) is also measured at the same two places along the frequency axis. Accordingly, IpN-2 less the measured improvement ΔIpN-2 of the uplink PIM for the selected downlink PIM avoidance action is lower on the higher-end of the available frequency range, or uplink spectrum, than the measured uplink interference plus noise IpN-1 less the measured improvement ΔIpN-1 of the uplink PIM for the same selected downlink PIM avoidance action on the lower-end of the available frequency range. That is, (IpN-2-ΔIpN-2)< (IpN-1-ΔIpN-1). Thus, the better starting point for carriers on which uplink transmission resources are to be transmitted in the data transmission instant is in the higher-end.

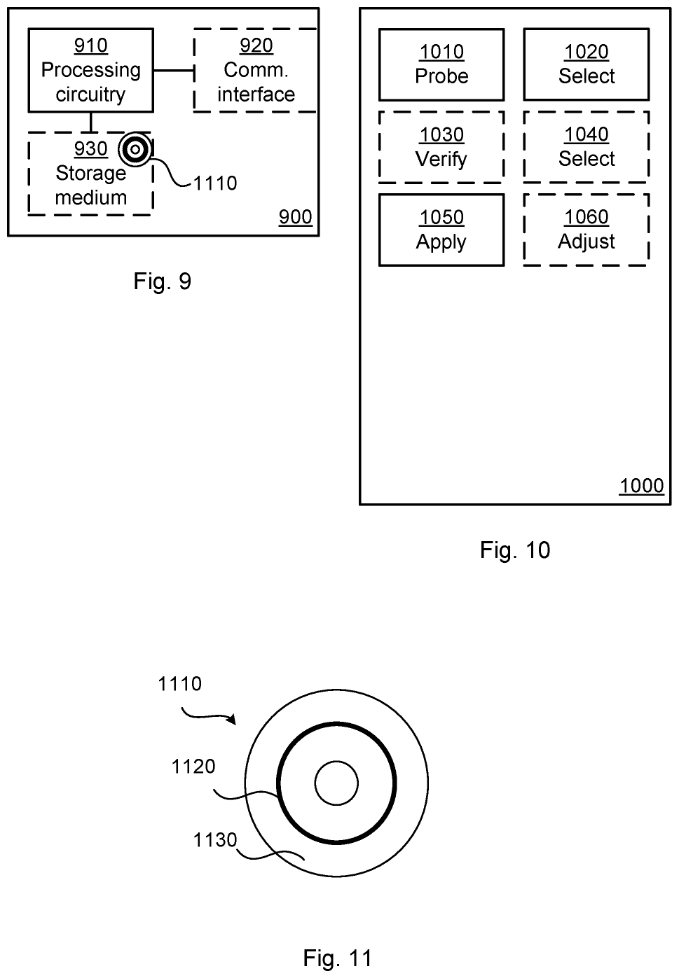

FIG. 9 schematically illustrates, in terms of a number of functional units, the components of a controller 900 according to an embodiment. Processing circuitry 910 is provided using any combination of one or more of a suitable central processing unit (CPU), multiprocessor, microcontroller 900, digital signal processor (DSP), etc., capable of executing software instructions stored in a computer program product 1110 (as in FIG. 11), e.g. in the form of a storage medium 930. The processing circuitry 910 may further be provided as at least one application specific integrated circuit (ASIC), or field programmable gate array (FPGA).

Particularly, the processing circuitry 910 is configured to cause the controller 900 to perform a set of operations, or steps, as disclosed above. For example, the storage medium 930 may store the set of operations, and the processing circuitry 910 may be configured to retrieve the set of operations from the storage medium 930 to cause the controller 900 to perform the set of operations. The set of operations may be provided as a set of executable instructions.

Thus the processing circuitry 910 is thereby arranged to execute methods as herein disclosed. The storage medium 930 may also comprise persistent storage, which, for example, can be any single one or combination of magnetic memory, optical memory, solid state memory or even remotely mounted memory. The controller 900 may further comprise a communications interface 920 at least configured for communications with other entities, functions, nodes and devices. As such the communications interface 920 may comprise one or more transmitters and receivers, comprising analogue and digital components. The processing circuitry 910 controls the general operation of the controller 900 e.g. by sending data and control signals to the communications interface 920 and the storage medium 930, by receiving data and reports from the communications interface 920, and by retrieving data and instructions from the storage medium 930. Other components, as well as the related functionality, of the controller 900 are omitted in order not to obscure the concepts presented herein.

FIG. 10 schematically illustrates, in terms of a number of functional modules, the components of a controller 1000 according to an embodiment. The controller 1000 of FIG. 10 comprises a number of functional modules; a probe module 1010 configured to perform step S102, a select module 1020 configured to perform step S104, and an apply module 1050 configured to perform step S110. The controller 1000 of FIG. 10 may further comprise a number of optional functional modules, such as any of a verify module 1030 configured to perform step S106, a select module 1040 configured to perform step S108, and an adjust module 1060 configured to perform step S112. In general terms, each functional module 1010:1060 may in one embodiment be implemented only in hardware and in another embodiment with the help of software, i.e., the latter embodiment having computer program instructions stored on the storage medium 930 which when run on the processing circuitry makes the controller 1000 perform the corresponding steps mentioned above in conjunction with FIG. 10. It should also be mentioned that even though the modules correspond to parts of a computer program, they do not need to be separate modules therein, but the way in which they are implemented in software is dependent on the programming language used. Preferably, one or more or all functional modules 1010:1060 may be implemented by the processing circuitry 910, possibly in cooperation with the communications interface 920 and/or the storage medium 930. The processing circuitry 910 may thus be configured to from the storage medium 930 fetch instructions as provided by a functional module 1010:1060 and to execute these instructions, thereby performing any steps as disclosed herein.

The controller 300, 400, 500, 600, 700, 900, 1000 may be provided as a standalone device or as a part of at least one further device. For example, the controller 300, 400, 500, 600, 700, 900, 1000 may be provided in a node of an access network or in a node of the core network. Alternatively, functionality of the controller 300, 400, 500, 600, 700, 900, 1000 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the controller 300, 400, 500, 600, 700, 900, 1000 may be executed in a first device, and a second portion of the of the instructions performed by the controller 300, 400, 500, 600, 700, 900, 1000 may be executed in a second device; the herein disclosed embodiments are not limited to any particular number of devices on which the instructions performed by the controller 300, 400, 500, 600, 700, 900, 1000 may be executed. Hence, the methods according to the herein disclosed embodiments are suitable to be performed by a controller 300, 400, 500, 600, 700, 900, 1000 residing in a cloud computational environment. Therefore, although a single processing circuitry 910 is illustrated in FIG. 9 the processing circuitry 910 may be distributed among a plurality of devices, or nodes. The same applies to the functional modules 1010:1060 of FIG. 10 and the computer program 1120 of FIG. 11.

FIG. 11 shows one example of a computer program product 1110 comprising computer readable storage medium 1130. On this computer readable storage medium 1130, a computer program 1120 can be stored, which computer program 1120 can cause the processing circuitry 910 and thereto operatively coupled entities and devices, such as the communications interface 920 and the storage medium 930, to execute methods according to embodiments described herein. The computer program 1120 and/or computer program product 1110 may thus provide means for performing any steps as herein disclosed.

In the example of FIG. 11, the computer program product 1110 is illustrated as an optical disc, such as a CD (compact disc) or a DVD (digital versatile disc) or a Blu-Ray disc. The computer program product 1110 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1120 is here schematically shown as a track on the depicted optical disk, the computer program 1120 can be stored in any way which is suitable for the computer program product 1110.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for passive intermodulation, PIM, avoidance, the method being performed by a controller, the method comprising:
performing, for a set of downlink PIM avoidance actions, uplink probing of a radio channel over which uplink PIM is received, the uplink probing for each downlink PIM avoidance action in the set of downlink PIM avoidance actions comprising obtaining, in a probing instant, a measured improvement of the uplink PIM when having applied the downlink PIM avoidance action;
selecting one of the downlink PIM avoidance actions based on the measured improvement for each of the downlink PIM avoidance actions as obtained during the uplink probing; and
applying the selected downlink PIM avoidance action to downlink transmission resources transmitted in a data transmission instant following the probing instant.

2. The method according to claim 1, wherein the measured improvement for each respective downlink PIM avoidance action is obtained as a difference between an average PIM impacted uplink metric level for when no downlink PIM avoidance action is applied and a PIM impacted uplink metric level for when said respective downlink PIM avoidance action is applied in the probing instant.

3. The method according to claim 2, wherein the PIM impacted uplink metric is any of: uplink signal to interference plus noise ratio, uplink interference plus noise, uplink throughput, block error rate, uplink spectral efficiency.

4. The method according to claim 1, wherein the data transmission instant is part of a transmission slot, and wherein one instant of the probing instant occurs every 10th to once every 1000th transmission slot.

5. The method according to claim 1, wherein the method further comprises:
verifying that the measured improvement of the uplink PIM of the selected downlink PIM avoidance action is higher than a threshold value before applying the selected downlink PIM avoidance action.

6. The method according to claim 1, wherein uplink PIM is affecting at least two PIM victims, wherein the uplink probing for each downlink PIM avoidance action is performed for each of the at least two PIM victims, and wherein the selected downlink PIM avoidance action is shared between downlink transmission resources associated with the at least two PIM victims according to the measured improvements of the uplink PIM resulting from the uplink probing for each of the at least two PIM victims.

7. The method according to claim 1, wherein the method further comprises:
adjusting, as a function of the measured improvement of the uplink PIM for the selected downlink PIM avoidance action, an uplink spectral efficiency affecting parameter, such as modulation and coding scheme or transport block size.

8. The method according to claim 1, wherein the downlink PIM avoidance actions pertain to any, or any combination, of: limiting downlink load in at least one carrier to a fixed limit, minimizing downlink load in at least one carrier to a fixed limit, limiting the downlink load from a certain side of downlink carriers when considered in the frequency domain, a sequence or repetition pattern according to which the selected downlink PIM avoidance action is to be performed.

9. The method according to claim 1, wherein the method further comprises:
selecting, as a function of the measured improvement of the uplink PIM for the selected downlink PIM avoidance action, a starting point in a frequency range for carriers on which uplink transmission resources are to be transmitted in the data transmission instant.

10. The method according to claim 1, wherein the downlink PIM avoidance action yielding highest measured improvement of the uplink PIM is selected.

11. A controller for passive intermodulation, PIM, avoidance, the controller comprising processing circuitry, the processing circuitry being configured to cause the controller to:
perform, for a set of downlink PIM avoidance actions, uplink probing of a radio channel over which uplink PIM is received, the uplink probing for each downlink PIM avoidance action in the set of downlink PIM avoidance actions comprising obtaining, in a probing instant, a measured improvement of the uplink PIM when having applied the downlink PIM avoidance action;
select one of the downlink PIM avoidance actions based on the measured improvement for each of the downlink PIM avoidance actions as obtained during the uplink probing; and
apply the selected downlink PIM avoidance action to downlink transmission resources transmitted in a data transmission instant following the probing instant.

12. (canceled)

13. The controller according to claim 11, wherein the measured improvement for each respective downlink PIM avoidance action is obtained as a difference between an average PIM impacted uplink metric level for when no downlink PIM avoidance action is applied and a PIM impacted uplink metric level for when said respective downlink PIM avoidance action is applied in the probing instant.

14. A computer storage medium storing a computer program for passive intermodulation, PIM, avoidance, the computer program comprising computer code which, when run on processing circuitry of a controller, causes the controller to:
perform, for a set of downlink PIM avoidance actions, uplink probing of a radio channel over which uplink PIM is received, the uplink probing for each downlink PIM avoidance action in the set of downlink PIM avoidance actions comprising obtaining, in a probing instant, a measured improvement of the uplink PIM when having applied the downlink PIM avoidance action;
select one of the downlink PIM avoidance actions based on the measured improvement for each of the downlink PIM avoidance actions as obtained during the uplink probing; and
apply the selected downlink PIM avoidance action to downlink transmission resources transmitted in a data transmission instant following the probing instant.

15. (canceled)

16. The method according to claim 2, wherein the method further comprises:
verifying that the measured improvement of the uplink PIM of the selected downlink PIM avoidance action is higher than a threshold value before applying the selected downlink PIM avoidance action.

17. The method according to claim 2, wherein uplink PIM is affecting at least two PIM victims, wherein the uplink probing for each downlink PIM avoidance action is performed for each of the at least two PIM victims, and wherein the selected downlink PIM avoidance action is shared between downlink transmission resources associated with the at least two PIM victims according to the measured improvements of the uplink PIM resulting from the uplink probing for each of the at least two PIM victims.

18. The method according to claim 2, wherein the method further comprises:
adjusting, as a function of the measured improvement of the uplink PIM for the selected downlink PIM avoidance action, an uplink spectral efficiency affecting parameter, such as modulation and coding scheme or transport block size.

19. The method according to claim 2, wherein the downlink PIM avoidance actions pertain to any, or any combination, of: limiting downlink load in at least one carrier to a fixed limit, minimizing downlink load in at least one carrier to a fixed limit, limiting the downlink load from a certain side of downlink carriers when considered in the frequency domain, a sequence or repetition pattern according to which the selected downlink PIM avoidance action is to be performed.

20. The method according to claim 4, wherein one instant of the probing instant occurs every 25th to once every 500th transmission slot.

21. The method according to claim 4, wherein one instant of the probing instant occurs every 50th to once every 150th transmission slot.

22. The method according to claim 4, wherein one instant of the probing instant occurs every 75th to once every 125th transmission slot.
